(19) United States
(12) Patent Application Publication
(10) Pub. No.: US 2002/0082155 A1
(43) Pub. Date: Jun. 27, 2002

(54) Barrier rib material for plasma display panel

(75) Inventors: Takayuki Mito, Kanzaki-gun (JP); Hiroyuki Oshita, Otsu-shi (JP); Masahiko Ouji, Moriyama-shi (JP); Kazuo Hadano, Otsu-shi (JP)

Correspondence Address: WILLIAM COLLARD, COLLARD & ROE, P.C., 1077 NORTHERN BOULEVARD, ROSLYN, NY, 11576, US

(73) Assignee: NIPPON ELECTRIC GLASS CO., LTD.

(21) Appl. No.: 09/975,619

(22) Filed: Oct. 11, 2001

(30) Foreign Application Priority Data
Oct. 12, 2000 (JP) 311541/2000

(51) Int. Cl. C03C 14/00

(52) U.S. Cl. 501/32

(57) ABSTRACT

In a barrier rib material, a filler powder includes from 10% to 90% by mass of a silica powder, from 10% to 90% by mass of an alumina powder, and from 0% to 40% by mass of a titanium oxide powder. The silica powder includes from 25% to 75% by mass of an α-quartz powder and/or a cristobalite powder, and from 25% to 75% by mass of a quartz glass powder.

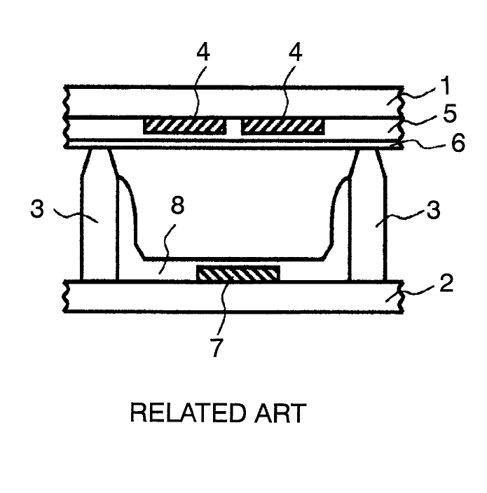

### BACKGROUND OF THE INVENTION

The present invention broadly relates to a barrier rib material for use in a plasma display panel.

A plasma display panel is generally a self-luminous flat display, and have various useful characteristics such as lightweight, a thin thickness and a wide viewing angle, thereby readily achieving a larger display area. Therefore, a great attention has been paid for such a plasma display as one of the most-promising display devices.

Referring now to a sole FIGURE, description will be hereinafter made about an existing plasma display panel as a related art.

The plasma display panel generally comprises a front glass substrate 1 and a rear glass substrate 2 facing each other, and barrier ribs 3 formed within the space between the substrates 1 and 2.

With this structure, the barrier ribs 3 are formed so as to divide a space between the substrates 1 and 2 into a plurality of gas discharge portions. A pair of transparent electrodes 4 are formed on the interior surface of the front glass substrate 1, and a voltage is applied between the transparent electrodes 4 to thereby induce plasma discharge.

A dielectric layer 5 is formed on the transparent electrodes 4 so as to fully cover the front glass substrate 1. A protective layer 6 made of MgO is formed on the dielectric layer 5 so as to stabilize the plasma formation.

A data electrode (an address electrode) 7 is formed on the rear glass substrate 2 between two barrier ribs 3, and a phosphor 8 is applied onto side walls of the barrier ribs 3 and onto the rear glass substrate 2 between the barrier ribs 3 so as to cover the data electrode 7.

Specifically, a voltage is applied between the transparent electrodes 4, and plasma discharge occurs in the gas discharge portion divided by the barrier ribs 3. An ultraviolet ray generated by the plasma discharge is irradiated to the phosphor 8, so that the phosphor 8 emits a visible light ray.

In the aforementioned plasma display panel, the barrier ribs 3 are generally formed on the rear glass substrate 2. The rear glass substrate 2 with the barrier ribs 3 is arranged so as to face the front glass substrate 1 to thereby constitute a panel.

In the panel structure shown in the FIGURE, the barrier ribs 3 are formed directly on the rear glass substrate 2. Alternatively, a protective dielectric layer is formed on the rear glass substrate 2 so as to cover and protect the data electrode 7, and then, the barrier ribs 3 are formed on the dielectric layer in some panel structures.

The barrier ribs 3 are generally formed by a printing lamination process or sandblast process. In the printing lamination process, printing is repeatedly carried out for a barrier rib forming portion by screen-printing with a plurality of times, and the barrier rib is formed via lamination due to lap applying.

In the sandblast process, the barrier ribs 3 are formed in the following manner. Initially, a layer of the barrier rib material is formed to a predetermined thickness directly on the rear glass substrate or with the interposition of a dielectric layer so as to fully cover the underlayer. The barrier rib material layer is formed by screen-printing a paste of the barrier rib material to the underlayer and drying the printed paste, or by laminating a green sheet onto the underlayer. Subsequently, a photoresist is applied onto the layer of the barrier rib material to form a resist film, the resist film is subjected to exposure to light irradiation and development, and portions where the resist film is not formed are removed by sandblasting to thereby form the barrier ribs at predetermined portions.

In general, such barrier rib materials must be cured at temperatures of 600° C. or lower to prevent deformation of a glass substrate, must have a thermal expansion coefficient of from 60×10⁻⁷/° C. to 85×10⁻⁷/° C. (at temperatures ranging from 30° C. to 300° C.), as much as those of the glass substrates so as to prevent a crack or peeling of the barrier ribs, and must be resistant to an alkali solution used in the formation of the barrier ribs. In this event, the barrier rib material generally includes a glass powder and a filler powder.

Glass having a low melting temperature is used as the glass powder, of which PbO glasses is widely used generally.

On the other hand, an alumina powder is widely used as the filler powder in order to maintain the configurations of the barrier ribs and to attain sufficient strength.

In the plasma display panel, the phosphor is irradiated with ultraviolet rays to thereby emit visible light as mentioned above, thus increasing power consumption.

Accordingly, the plasma display panel must be reduced in power consumption. For this purpose, a reduction in the dielectric constant of the barrier rib material is believed to be effective.

In order to reduce the dielectric constant of the barrier ribs, Japanese Unexamined Patent Publication (A) No. H 11-162361 proposes a barrier rib material containing two or more types of quartz glass, α-quartz and cristobalite, as fillers. However, when this barrier rib material is used, the resulting barrier rib is not mechanically strong enough.

### SUMMARY OF THE INVENTION

It is therefore an object of the present invention to provide a barrier rib material for a plasma display panel which is low in dielectric constant and which is capable of forming a barrier rib having sufficient strength for practical application.

After intensive investigations, the present inventors have found that the objects can be achieved by the use of specific proportions of an alumina powder and two or more silica powders as a filler powder. The present invention has been accomplished based on these findings.

Specifically, the present invention provides, in one aspect, a barrier rib material for a plasma display panel which includes a glass powder and a filler powder.

In the barrier rib material, the filler powder includes from 10% to 90% by mass of a silica powder, from 10% to 90% by mass of an alumina powder, and from 0% to 40% by mass of a titanium oxide powder.

The silica powder includes from 25% to 75% by mass of an α-quartz powder and/or a cristobalite powder, and from 25% to 75% by mass of a quartz glass powder.

The barrier rib material for a plasma display panel of the present invention has a low dielectric constant and can form a barrier rib having sufficient strength for practical application. Additionally, the barrier rib material can have a thermal expansion coefficient similar to that of a glass substrate. The barrier rib material is therefore suitable and useful as a barrier rib material for a plasma display panel.

### BRIEF DESCRIPTION OF THE DRAWINGS

A sole FIGURE is a sectional view of a structure of a related plasma display panel.

### DESCRIPTION OF PREFERRED EMBODIMENTS

The barrier rib material for a plasma display panel of the present invention (hereinafter briefly referred to as “barrier rib material”) uses, as a silica powder, α-quartz (140×10⁻⁷/° C.) and/or cristobalite (500×10⁻⁷/° C.), each having a high thermal expansion coefficient, and a quartz glass (5×10⁻⁷/° C.) having a low thermal expansion coefficient. The entire barrier rib material can have a thermal expansion coefficient of from 60×10⁻⁷/° C. to 85×10⁻⁷/° C.

In addition, each of the α-quartz, cristobalite and quartz glass has a low dielectric constant, thus reducing the dielectric constant of the entire barrier rib material. The barrier rib material also comprises a predetermined amount of an alumina powder as a filler in addition to the silica powder, and thus the resulting barrier ribs can have sufficient strength for practical application.

The present invention specifies the above composition of the filler powder in the barrier rib material of the present invention for the following reasons.

The silica powder serves to reduce the dielectric constant of the barrier rib. If the content of the silica powder in the filler powder is less than 10% by mass, the barrier rib has an increased dielectric constant, and if it exceeds 90% by mass, the barrier rib has decreased strength and cannot maintain its configuration sufficiently. The filler powder preferably comprises from 30% to 70% by mass of the silica powder.

The silica powder includes high-expansion α-quartz and/or cristobalite powder and a low-expansion quartz glass powder. Both the α-quartz powder and cristobalite powder can be used in combination or alone. In the latter case, the α-quartz powder is preferably used due to its availability.

The silica powder comprises from 25% to 75% by mass of the α-quartz powder and/or cristobalite powder and from 25% to 75% by mass of the quartz glass powder. If the total content of the α-quartz powder and cristobalite powder in the silica powder is less than 25% by mass, the barrier rib material has a decreased thermal expansion coefficient.

In contrast, if it exceeds 75% by mass, the barrier rib material has an excessively increased thermal expansion coefficient. The silica powder preferably comprises from 30% to 70% by mass of the α-quartz powder and/or cristobalite powder and from 30% to 70% by mass of the quartz glass powder.

Specifically, the silica powder desirably includes from 25% to 75% by mass of the α-quartz powder, from 0% to 50% by mass of the cristobalite powder and from 25% to 75% by mass of the quartz glass powder.

More preferably, the silica powder comprises from 30% to 70% by mass of the α-quartz powder, from 0% to 40% by mass of the cristobalite powder and from 30% to 70% by mass of the quartz glass powder.

The alumina powder serves to improve the strength of the barrier rib. If the content of the alumina powder in the filler powder is less than 10% by mass, the barrier rib has insufficient strength and cannot maintain its configuration.

In contrast, if it exceeds 90% by mass, the barrier rib cannot have a sufficiently reduced dielectric constant. The filler powder preferably comprises from 30% to 70% by mass of the alumina powder.

Titanium oxide powder serves to increase the reflectance of the barrier ribs and thereby improves the luminance of the plasma display panel. If the content of the titanium oxide powder in the filler powder exceeds 40% by mass, the barrier rib has an increased dielectric constant. The filler powder preferably comprises from 0% to 35% by mass of the titanium oxide powder.

Regarding particle size distribution, the filler powder should preferably have a 50%-point cumulative particle size distribution (D50) of from 0.3 to 6 μm and a maximum particle diameter (Dmax) of from 5 to 20 μm.

When D50 is equal to or more than 0.3 μm, the barrier rib material supplied in the form of a paste can be easily and Theologically controlled. When D50 is less than or equal to 6 μm, the resulting barrier rib becomes dense. When Dmax is equal to or more than 5 μm, the barrier rib material supplied in the form of a paste can be easily and rheologically controlled.

When Dmax is less than or equal to 20 μm, the resulting barrier rib becomes dense, and the material paste becomes resistant to separation.

The barrier rib material of the present invention comprises the filler powder and glass powder. Such glass powder for use in the present invention is not specifically limited as long as it has a thermal expansion coefficient of from 60×10⁻⁷/° C. to 90×10⁻⁷/° C. (at temperatures ranging from 30° C. to 300° C.), a dielectric constant of less than or equal to 12.0 at 25° C. at 1 MHz and a softening point of from 480° C. to 630° C.

Preferred glass powders are powders of a PbO—B₂O₃—SiO₂ glass, a BaO—ZnO—B₂O₃—SiO₂ glass and a ZnO—Bi₂O₃—B₂O₃—SiO₂ glass.

The PbO—B₂O₃—SiO₂ glass preferably comprises from 35% to 75% by mass of PbO, from 0% to 50% by mass of B₂O₃, from 8% to 30% by mass of SiO₂, from 0% to 10% by mass of Al₂O₃, from 0% to 10% by mass of ZnO, from 0% to 10% by mass of at least one of CaO, MgO, SrO and BaO and from 0% to 6% by mass of at least one of SnO₂, TiO₂ and ZrO₂.

The BaO—ZnO—B₂O₃—SiO₂ glass preferably comprises from 20% to 50% by mass of BaO, from 25% to 50% by mass of ZnO, from 10% to 35% by mass of B₂O₃ and from 0% to 10% by mass of SiO₂.

The ZnO—Bi₂O₃—B₂O₃—SiO₂ glass preferably comprises from 25% to 45% by mass of ZnO, from 15% to 40% by mass of Bi₂O₃, from 10% to 30% by mass of B₂O₃, from 0.5% to 10% by mass of SiO₂ and from 0% to 24% by mass of at least one of CaO, MgO, SrO and BaO.

The glass powder should preferably have a 50%-point of cumulative particle size distribution (D50) of from 1 to 7 μm and a maximum particle diameter (Dmax) of from 5 to 30 μm. When D50 is equal to or more than 1 μm and Dmax is equal to or more than 5 μm, the barrier rib can satisfactorily maintain its configuration.

When D50 is less than or equal to 7 μm and Dmax is less than or equal to 30 μm, the barrier rib material has an improved sinterability, thereby readily obtaining a dense barrier rib.

The mass ratio of the glass powder to the filler powder in the barrier rib material is preferably from 65:35 to 85:15. When the mass ratio is less than or equal to 85:15, the barrier rib material becomes less flowable during the curing operation and thereby the configuration of the resulting barrier rib is easily maintained.

When the mass ratio is equal to or more than 65:35, the barrier rib material has an improved sinterability, thus easily forming a dense barrier rib.

By using the barrier rib material of the present invention having the above configuration, a barrier rib having a dielectric constant of less than or equal to 10.0, a thermal expansion coefficient of from 60×10⁻⁷/° C. to 85×10⁻⁷/° C. (at temperatures ranging from 30° C. to 300° C.) and sufficient mechanical strength for practical application can be formed.

The barrier rib material of the present invention can be used in the following manner, for example, in the form of a paste or green sheet.

When the barrier rib material is used in the form of a paste, the paste may comprise a thermoplastic resin, a plasticizer, a solvent or medium, and other additives in addition to the glass powder and the filler powder. The total content of the glass powder and the filler powder in the paste is generally from about 30% to about 90% by mass.

The thermoplastic resin serves to improve the strength of a dried film of the paste and to impart plasticity or flexibility thereto. The content of the thermoplastic resin in the paste is generally from about 0.1% to about 20% by mass. Such thermoplastic resin includes, but is not limited to, poly(butyl methacrylate), polyvinyl butyral, poly(methyl methacrylate), poly(ethyl methacrylate), and ethyl cellulose. The thermoplastic resin can be used alone or in combination.

The plasticizer serves to control the drying rate and to impart plasticity or flexibility to a dried film of the paste. The content of the plasticizer in the paste is generally from about 0% to about 10% by mass. Such plasticizer includes, but is not limited to, butyl benzyl phthalate, dioctyl phthalate, diisooctyl phthalate, dicapryl phthalate [di(2-octyl) phthalate], and dibutyl phthalate. The plasticizer can be used alone or in combination.

The solvent serves to convert the barrier rib material into a paste. The content of the solvent in the paste is generally from about 10% to about 30% by mass. Such solvent includes, but is not limited to, terpineol, diethylene glycol monobutyl ether acetate, and 2,2,4-trimethyl-1,3-pentanediol monoisobutylate. The solvent can be used alone or in combination.

The paste can be produced by preparing the glass powder, filler powder, thermoplastic resin, plasticizer, solvent, and where necessary, other additional components, and kneading these components in predetermined compositional ratios.

The barrier rib can be formed by using the barrier rib material in the form of such a paste, for example, in the following manner. Initially, the paste is applied by screen printing or batch coating to form a coating layer having a predetermined thickness, the coating layer is dried, and a resist film is formed on the coating layer and is subjected to light exposure and development.

Successively, an unnecessary portion of the coating layer is removed by sandblasting. Thereafter, curing is carried out so as to obtain the barrier rib with a predetermined configuration.

When the barrier rib material is used in the form of a green sheet, the green sheet comprises a thermoplastic resin, a plasticizer, and where necessary, other additives in addition to the glass powder and the filler powder. The total content of the glass powder and filler powder in the green sheet is generally from about 60% to 80% by mass.

Such thermoplastic resin and plasticizer for use in the green sheet include similar thermoplastic resin and plasticizer for use in the preparation of the paste. The content of the thermoplastic resin in the green sheet is generally from about 5% to about 30% by mass, and the content of the plasticizer is generally from about 0% to about 10% by mass.

The green sheet is generally produced in the following manner. Initially, the glass powder, filler powder, thermoplastic resin, plasticizer, and where necessary, other additives are prepared, a major solvent such as toluene and a secondary solvent such as isopropyl alcohol are added to the above-prepared components to thereby yield a slurry. The slurry is applied onto a film such as poly(ethylene terephthalate) (PET) by the doctor blade process to thereby form a sheet. The solvent is then removed by drying to thereby yield a green sheet.

The above-prepared green sheet is applied onto a portion, where a glass layer is to be formed, by thermocompression bonding and is fired or cured to thereby yield a glass layer. In the formation of barrier rib, the green sheet is applied by thermocompression bonding and is then subjected to a procedure similar to that in the paste to thereby form barrier rib having a predetermined configuration.

In the above description, the method of forming the barrier rib is explained by taking the sandblasting process using a paste or green sheet as an example. In addition to this process, however, the barrier rib material of the present invention can also be applied to other formation techniques such as printing lamination, lift-off process, a process using a photosensitive paste, a process using a photosensitive green sheet, press molding and transfer printing.

### EXAMPLES

The present invention will be explained in further detail with reference to several examples and comparative examples below, which are not intended to limit the scope of the invention.

[Glass Powders]

Tables 1 to 3 show the compositions and characteristics of the glass powders for use in the barrier rib materials for plasma display panels. Tables 1 to 3 relate to a PbO—B₂O₃—SiO₂ glass, a BaO—ZnO—B₂O₃—SiO₂ glass and a ZnO—Bi₂O₃—B₂O₃—SiO₂ glass, respectively.

TABLE 1

| | A | B | C |
|---|---|---|---|
| COMPOSITION (mass %) | | | |
| PbO | 40.0 | 55.0 | 63.0 |
| B₂O₃ | 45.0 | 30.0 | 10.0 |
| SiO₂ | 10.0 | 10.0 | 27.0 |
| Al₂O₃ | 5.0 | 5.0 | — |
| SOFTENING POINT (° C.) | 570 | 540 | 550 |
| DIELECTRIC CONSTANT | 6.5 | 8.0 | 11.0 |
| (25° C., 1 MHZ) | | | |
| COEFFICIENT OF | 65 | 68 | 70 |
| THERMAL EXPANSION | | | |
| [30-300° C. (×10⁻⁷/° C.)] | | | |

TABLE 2

| | D | E | F |
|---|---|---|---|
| COMPOSITION (mass %) | | | |
| BaO | 38.0 | 33.7 | 26.6 |
| ZnO | 30.6 | 42.9 | 42.3 |
| B₂O₃ | 31.4 | 16.8 | 24.1 |
| SiO₂ | — | 6.6 | 7.0 |
| SOFTENING POINT (° C.) | 602 | 592 | 615 |
| DIELECTRIC CONSTANT | 9.5 | 10.0 | 9.0 |
| (25° C., 1 MHZ) | | | |
| COEFFICIENT OF | 85 | 71 | 67 |
| THERMAL EXPANSION | | | |
| [30-300° C. (×10⁻⁷/° C.)] | | | |

TABLE 3

| | G | H | I |
|---|---|---|---|
| COMPOSITION (mass %) | | | |
| ZnO | 32.0 | 33.0 | 27.0 |
| Bi₂O₃ | 26.0 | 26.0 | 39.0 |
| B₂O₃ | 27.0 | 21.0 | 19.0 |
| SiO₂ | 2.0 | 5.0 | 7.0 |
| CaO | 13.0 | 15.0 | 8.0 |
| SOFTENING POINT (° C.) | 565 | 576 | 568 |
| DIELECTRIC CONSTANT | 11.0 | 10.5 | 11.0 |
| (25° C., 1 MHZ) | | | |
| COEFFICIENT OF | 85 | 83 | 85 |
| THERMAL EXPANSION | | | |
| [30-300° C. (×10⁻⁷/° C.)] | | | |

Glass powders (Samples A to 1) were prepared in the following manner. Initially, glass materials composed of oxides were uniformly admixed in the compositions indicated in Tables 1 to 3, the mixtures were placed in a platinum crucible and were melted at 1250° C. for 2 hours to thereby yield uniform glass. The glass was pulverized and classified to yield a series of glass powders having D50 of 3 μm and Dmax of 20 μm.

The particle size distribution of the glass powders was determined using a laser diffraction particle size analyzer (produced by Shimadzu Corporation under the trade name of SALD-2000J) to calculate D50. In this procedure, the maximum particle diameter (Dmax) was defined as the 99.9% point of a cumulative particle size distribution.

In the calculation of the particle size distribution, 1.9 and 0.05i were employed as the real part and imaginary part of a complex index of refraction, respectively.

The above-prepared glass powders were found to have a softening point of from 540° C. to 615° C., a dielectric constant of from 6.5 to 11.0, and a thermal expansion coefficient of from 65×10⁻⁷/° C. to 85×10⁻⁷/° C. (at temperatures ranging from 30° C. to 300° C.).

[Filler Powders]

Table 4 shows the compositions of the filler powders for use in the barrier rib material for the plasma display panel.

TABLE 4

| | a | b | c | d | e | f | g | h | i |
|---|---|---|---|---|---|---|---|---|---|
| COMPOSITION | 50 | 50 | 30 | 50 | 30 | 50 | 50 | — | 100 |
| (mass %) | | | | | | | | | |
| silica | | | | | | | | | |
| α-quartz | 60 | 75 | 50 | 70 | 30 | 95 | 3 | — | 50 |
| silica glass | 40 | 25 | 50 | 30 | 70 | 5 | 97 | — | 50 |
| alumina | 50 | 35 | 70 | 50 | 70 | 50 | 50 | 100 | — |
| titanium oxide | — | 15 | — | — | — | — | — | — | — |

Filler powders (Samples a to i) were prepared by uniformly admixing components in the compositions indicated in Table 4. In this procedure, the α-quartz powder, quartz glass powder and alumina powder each had D50 of 2.0 μm and Dmax of 10.0 μm. The titanium oxide powder had D50 of 0.5 μm and Dmax of 5.0 μm.

[Barrier Rib Materials]

Tables 5 and 6 show the characteristics of examples (Samples Nos. 1 to 11) and comparative examples (Samples Nos. 12 to 15) of the barrier rib materials for plasma display panels.

TABLE 5

| | EXAMPLES | | | | | | |
|---|---|---|---|---|---|---|---|
| | 1 | 2 | 3 | 4 | 5 | 6 | 7 |
| GLASS POWDER TYPE | A | B | C | D | E | F | G |
| CONTENT (mass %) | 85 | 70 | 65 | 85 | 70 | 85 | 75 |
| FILLER POWDER TYPE | e | a | c | b | d | c | b |
| CONTENT | 15 | 30 | 35 | 15 | 30 | 15 | 25 |
| (mass %) | | | | | | | |
| SOFTENING | 575 | 565 | 570 | 610 | 610 | 620 | 570 |
| POINT (° C.) | | | | | | | |
| DIELECTRIC CONSTANT | 10.0 | 7.0 | 10.0 | 9.0 | 9.0 | 8.5 | 10.0 |
| (25° C., 1 MHZ) | | | | | | | |
| COEFFICIENT OF | 65 | 67 | 69 | 82 | 70 | 66 | 81 |
| THERMAL EXPANSION | | | | | | | |
| [30-300° C. (×10⁻⁷/° C.)] | | | | | | | |
| CRACKING LOAD (g) | 200 | 200 | 250 | 200 | 200 | 200 | 200 |

TABLE 6

| | EXAMPLES | | | | COMPARATIVE EXAMPLES | | | |
|---|---|---|---|---|---|---|---|---|
| | 8 | 9 | 10 | 11 | 12 | 13 | 14 | 15 |
| GLASS POWDER TYPE | H | I | B | H | D | A | G | G |
| CONTENT (mass %) | 75 | 70 | 90 | 60 | 80 | 80 | 80 | 80 |
| FILLER POWDER TYPE | a | c | e | a | f | g | h | i |
| CONTENT (mass %) | 25 | 30 | 10 | 40 | 20 | 20 | 20 | 20 |
| SOFTENING POINT (° C.) | 585 | 580 | 545 | 605 | 620 | 580 | 575 | 570 |
| DIELECTRIC CONSTANT | 9.0 | 10.0 | 8.0 | 7.5 | 8.5 | 6.0 | 11.0 | 9.5 |
| (25° C., 1 MHZ) | | | | | | | | |
| COEFFICIENT OF | 80 | 83 | 67 | 76 | 95 | 54 | 83 | 78 |
| THERMAL EXPANSION | | | | | | | | |
| [30-300° C. (10⁻⁷/° C.)] | | | | | | | | |
| CRACKING LOAD (g) | 200 | 200 | 150 | 250 | 200 | 200 | 200 | 100 |

The barrier rib materials for plasma display panels were prepared by admixing each of the glass powders shown in Tables 1 to 3 with each of the filler powders shown in Table 4 in the compositional ratios indicated in Tables 5 and 6.

The softening point, dielectric constant, thermal expansion coefficient and cracking load of the barrier rib materials were determined.

Samples Nos. 1 to 11 as inventive examples each had a low dielectric constant of less than or equal to 10.0 and a cracking load of equal to or more than 150 g and had sufficient mechanical strength for practical use.

Additionally, these samples each had a low softening point of less than or equal to 620° C. and thereby formed barrier ribs at firing temperatures of less than or equal to 600° C. These samples also had a thermal expansion coefficient of from 65×10⁻⁷/° C. to 83×10⁻⁷/° C., close to that of a glass substrate, thus avoiding a crack or peeling of the barrier ribs.

In the determination of the softening point, each of the samples was subjected to differential thermal analysis using a macro differential thermal analyzer, and the softening point was defined as the temperature at a fourth inflection point in the resulting curve.

In the determination of the dielectric constant, each of the samples was subjected to dry powder pressing and firing (curing), and the dielectric constant of the fired sample was determined at 25° C. and, 1 MHz by a disk process. Each of the samples was separately subjected to dry powder pressing and firing, and the fired sample was ground to a cylinder 4 mm in diameter and 40 mm in length. The thermal expansion of the cylinder was measured by a method pursuant to Japanese Industrial Standards (JIS) R3102, and the thermal expansion coefficient within temperatures ranging from 30° C. to 300° C. was calculated.

The cracking load indicates the mechanical strength of the barrier rib material, and the mechanical strength of the barrier rib material increases with an increasing cracking load. The cracking load was determined in the following manner. Initially, each of the barrier rib materials was fired at its softening point for 10 minutes to yield a sample, and a diamond indenter for use in a Vickers' hardness tester was pressed into the surface of the fired sample. In this procedure, the cracking load was defined as the load at which cracking occurred in a corner of the resulting square indentation.

In the above examples, barrier rib materials using a cristobalite powder are not detailed. However, a cristobalite powder can replace part or all of the α-quartz powder in the barrier rib materials.

Other embodiments and variations will be obvious to those skilled in the art, and this invention is not to be limited to the specific areas stated above.

What is claimed is:

1. A barrier rib material containing a glass powder and a filler powder for use in a plasma display panel, wherein the filler powder comprises:
10% to 90% by mass of a silica powder,
10% to 90% by mass of an alumina powder, and
0% to 40% by mass of a titanium oxide powder, and
the silica powder comprising:
25% to 75% by mass of an α-quartz powder and/or a cristobalite powder, and
25% to 75% by mass of a quartz glass powder.

2. A barrier rib material as claimed in claim 1, wherein:
the silica powder comprises from 25% to 75% by mass of an α-quartz powder, from 0% to 50% by mass of a cristobalite powder, and from 25% to 75% by mass of a quartz glass powder.

3. A barrier rib material as claimed in claim 1, wherein:
the silica powder comprises from 25% to 75% by mass of an α-quartz powder and from 25% to 75% by mass of a quartz glass powder.

4. A barrier rib material claimed as claim 1 or claim 2, wherein:
the mass ratio of the glass powder to the filler powder is from 65:35 to 85:15.
